(19) United States
(12) Patent Application Publication
(10) Pub. No.: US 2023/0133648 A1
(43) Pub. Date: May 4, 2023

(54) A METHOD OF FABRICATING AQUEOUS SLURRY FOR UNIFORM COATING ON HYDROPHOBIC SEPARATOR AND A FUNCTIONAL SEPARATOR FABRICATED THEREBY

(71) Applicant: ELECTRONICS AND TELECOMMUNICATIONS RESEARCH INSTITUTE, Daejeon (KR)

(72) Inventors: Ju Young KIM, Daejeon (KR); Young Gi LEE, Daejeon (KR); Seok Hun KANG, Daejeon (KR); Young Sam PARK, Daejeon (KR); Dong Ok SHIN, Daejeon (KR); Jae Cheol CHOI, Daejeon (KR)

(21) Appl. No.: 17/715,296

(22) Filed: Apr. 7, 2022

(30) Foreign Application Priority Data
Nov. 1, 2021 (KR) 10-2021-0148186

(51) Int. Cl. C08F 16/06; H01M 4/62

(52) U.S. Cl. CPC C08F 16/06; H01M 4/621; H01M 4/622

(57) ABSTRACT

A composition of aqueous slurry capable of exerting uniform coating on a hydrophobic separator for a secondary battery is disclosed. Unlike other aqueous polymers, a polyvinyl alcohol-based polymer can be physically and chemically bound to a surface of a hydrophobic separator made of polyolefins such as polyethylene, polypropylene, and the like. Therefore, when the aqueous slurry including the polyvinyl alcohol-based polymer is fabricated and a hydrophobic separator is coated with the aqueous slurry, the hydrophobic separator may be smoothly coated with the aqueous slurry.

### CROSS-REFERENCE TO RELATED APPLICATION

This application claims priority to and the benefit of Korean Patent Application No. 10-2021-0148186, filed on Nov. 1, 2021, the disclosure of which is incorporated herein by reference in its entirety.

### BACKGROUND

### 1. Field of the Invention

The present invention relates to a functional separator applied to secondary batteries such as a lithium-ion battery and the like, and more particularly, to a method of fabricating an aqueous slurry capable of being uniformly coated on a hydrophobic separator.

### 2. Description of Related Art

Secondary batteries, in particular, lithium-ion secondary batteries, are energy storage devices that exhibit high energy capacity and stable output characteristics, and have been applied to various fields ranging from portable power sources to electric cars, energy storage systems, and the like. However, because the secondary batteries use a non-aqueous electrolyte solution having a high risk of combustion and operate in a high voltage range, fire accidents may happen due to their unexpected behavior. In addition, the recent industrial trend of secondary batteries has been changed from small secondary batteries, which are used as power sources for portable devices such as mobile phones, and the like, to medium-to-large secondary batteries for electric cars, energy storage systems, and the like. Therefore, their stability problems are becoming more prominent.

To secure the stability of the secondary batteries, various methods have been applied to the secondary batteries. The secondary batteries preferentially require external environment management to prevent them from being exposed to ignition environments (i.e., a high temperature), and also employ safety devices such as a protection circle module (PCM), a positive temperature coefficient (PTC), and the like. Also, a flame-retardant/non-combustible electrolyte solution, additives for overcharge protection, and the like are often used to configure the secondary batteries, and positive electrode or negative electrode active materials having high thermal stability are also used. In addition, research on securing thermal stability by coating a separator with an inorganic or organic functional material in the step of fabricating a separator has been reported.

Coating the separator with the inorganic or organic functional material is mostly performed through a slurry-based film-thickening process. In general, the separator is coated with a slurry prepared using an organic solvent such as n-methyl-2-pyrrolindone. However, a water-based fabrication process is further preferred for the purpose of resolving environmental issues and reducing battery manufacturing costs.

However, since the separator is made up of polyolefin-based materials having high hydrophobicity, it is known that, when an aqueous slurry is used, it is difficult to uniformly coat the separator with the aqueous slurry due to poor wetting properties on a surface of the separator. To improve these properties, a surface modification method of converting the nature of the separator from hydrophobicity to hydrophilicity is often presented.

### SUMMARY OF THE INVENTION

It is an object of the present invention to provide a technology of uniform coating on a hydrophobic separator for a secondary battery with a good wetting property.

To achieve the object, an aqueous slurry composition capable of exerting uniform coating on a hydrophobic separator for a secondary battery is provided.

Specifically, a surface of the hydrophobic separator may be modified and simultaneously smoothly coated with an aqueous slurry using a behavior of a certain polymer being physically and chemically bound to a surface of the hydrophobic separator. Unlike other aqueous polymers, a polyvinyl alcohol-based polymer may be physically and chemically bound to a surface of a hydrophobic separator made of polyolefins such as polyethylene, polypropylene, and the like. This is due to the low interfacial energy between the polyvinyl alcohol and the polyolefins. The hydrophobic separator to which the polyvinyl alcohol-based polymer is bound may exhibit an excellent wetting property with respect to water due to a hydroxyl group (-OH) of the polyvinyl alcohol, compared to the polyolefins. Therefore, when the aqueous slurry including the polyvinyl alcohol-based polymer is fabricated and a hydrophobic separator is coated with the aqueous slurry, the hydrophobic separator may be smoothly coated with the aqueous slurry.

These properties may be equally exhibited even in an aqueous slurry in which a combination of heterogeneous binders, which have different chemical structures from polyvinyl alcohol, is mixed. Therefore, when an aqueous binder, which is generally known to have no ability to coat the hydrophobic separator, is mixed with the polyvinyl alcohol-based polymer to constitute a slurry, a coating layer may be smoothly formed. This indicates that the properties of the functional separator may be further improved because the properties of various aqueous binders may be used in combination.

The above-described configurations and operations of the present invention will become more apparent from embodiments described in detail below with reference to the drawings.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The above and other objects, features and advantages of the present invention will become more apparent to those of ordinary skill in the art by describing exemplary embodiments thereof in detail with reference to the accompanying drawings, in which:

FIG. 1 shows the results of coating a separator with an aluminum oxide/polyvinyl alcohol layer using an aqueous slurry having a viscosity of 229.1 cP;

FIG. 2 shows the results of electron microscope analysis of the layer shown in FIG. 1;

FIG. 3 shows the results of energy-dispersive X-ray spectroscopic analysis of the layer shown in FIG. 1;

FIG. 4 shows the results of electron microscope and energy-dispersive X-ray spectroscopic analyses of a cross-section of the layer shown in FIG. 1;

FIG. 5 shows the results of coating a separator with an aluminum oxide/polyvinyl alcohol layer using an aqueous slurry having a viscosity of 100.6 cP;

FIG. 6 shows the results of coating a separator with an aluminum oxide/polyvinyl alcohol layer using an aqueous slurry having a viscosity of 26.7 cP;

FIG. 7 shows the results of coating a separator with an aluminum oxide/polyvinyl alcohol layer using an aqueous slurry having a viscosity of 14.7 cP;

FIG. 8 shows the results of coating a separator with an aluminum oxide/polyvinyl alcohol layer using an aqueous slurry having a viscosity of 2,026 cP;

FIG. 9 shows the results of coating a separator with an aluminum oxide/polyvinyl alcohol layer using an aqueous slurry having a viscosity of 1,074 cP;

FIG. 10 shows an area ratio of the covered surface with the slurry applied to the separator as a function of the viscosity of the aqueous slurry;

FIG. 11 shows the results of coating a separator with an aluminum oxide/polyvinyl alcohol/pectin layer;

FIG. 12 shows the results of electron microscope and energy-dispersive X-ray spectroscopic analyses of the results shown in FIG. 11;

FIG. 13 shows the results of coating a separator with an aluminum oxide/pectin layer;

FIG. 14 shows the results of electron microscope and energy-dispersive X-ray spectroscopic analyses of the results shown in FIG. 13;

FIG. 15 shows the results of coating a separator with an aluminum oxide/polyvinyl alcohol/sodium carboxymethyl cellulose layer;

FIG. 16 shows the results of coating a separator with an aluminum oxide/sodium carboxymethyl cellulose layer.

### DETAILED DESCRIPTION OF EXEMPLARY EMBODIMENTS

Advantages and features of the present invention and methods for achieving them will be made clear from embodiments described in detail below with reference to the accompanying drawings. However, the present invention may be embodied in many different forms and should not be construed as being limited to the embodiments set forth herein. Rather, these embodiments are provided so that this disclosure will be thorough and complete and will fully convey the scope of the present invention to those of ordinary skill in the technical field to which the present invention pertains. The present invention is defined by the claims.

Meanwhile, terms used herein are for the purpose of describing the embodiments and are not intended to limit the present invention. As used herein, the singular forms include the plural forms as well unless the context clearly indicates otherwise. The term “comprise” or “comprising” used herein does not preclude the presence or addition of one or more elements, steps, operations, and/or devices other than stated elements, steps, operations, and/or devices.

Hereinafter, exemplary embodiments of the present invention will be described in detail with reference to the accompanying drawings. In adding reference numerals to elements of each drawing, the same elements may have the same reference numeral as much as possible even if the elements are shown in different drawings. Further, in describing the present invention, the detailed description of a related known configuration or function will be omitted when it obscures the gist of the present invention.

In the present invention, an aqueous slurry is in the form in which a functional material, an aqueous binder, and water are uniformly mixed.

The functional material may include various materials such as insulators, semiconductors, conductors, ceramics, metals, and the like. Among these, the typically widely used materials are aluminum oxide, silicon dioxide, titanium dioxide, zirconium oxide, ruthenium oxide, iron oxide, cobalt oxide, nickel oxide, boehmite, copper, silver, iron, nickel, carbon black, carbon nanotubes, graphene, graphite, and the like. These materials may be used alone or in combination. The particle sizes of these materials need to be controlled to proper levels because the particle sizes are associated with the mobility of a liquid electrolyte. In general, when an average particle diameter of the functional material is too high, such as several tens of micrometers, or too small, such as a few nanometers, the movement of lithium ions may be excessively increased, which may adversely affect battery performance. Therefore, particles having a size of several tens of nanometers to a few micrometers, preferably particles having a size of 100 nanometers to 5 micrometers (based on the average particle size) may be used as the functional material used for the separator for a secondary battery.

The aqueous binder should include a polyvinyl alcohol-based polymer, that is, polyvinyl alcohol, a polyvinyl alcohol derivative, or a copolymer including polyvinyl alcohol. Such a polyvinyl alcohol-based polymer binder may modify a surface of the hydrophobic separator to improve a wetting property of the aqueous slurry with which the hydrophobic separator is coated. That is, the polyvinyl alcohol-based polymer binder may be physicochemically bound to a polyolefin of the hydrophobic separator to regulate the surface energy of the separator. In this way, the polyvinyl alcohol-based polymer binder aids in smoothly coating the hydrophobic separator with the aqueous slurry.

The polyvinyl alcohol-based polymer binder may be used alone as the aqueous binder, but may also be used in combination with a heterogeneous aqueous binder other than the polyvinyl alcohol-based polymer. The heterogeneous aqueous binder includes polyethylene oxide (PEO), polyvinyl pyrrolidone (PVP), polyacrylamide, poly N-(2-hydroxypropyl)methacrylamide (HPMA), polyethyleneimine(polyethyleneimine, PEI), polyacrylic acid (PAA), divinyl ether-maleic anhydride, polyoxazoline, polyphosphate, polyphosphazene, xanthan gum, pectin, dextran, carrageenan, guar gum, sodium carboxymethyl cellulose, sodium alginate, hyaluronic acid, albumin, and the like. The material(s) selected from the above may be used alone or in combination, or may also be used as a copolymer.

Polyvinyl alcohol included in the polyvinyl alcohol-based polymer binder is generally prepared through the hydrolysis of polyvinyl acetate, wherein the solubility of polyvinyl alcohol in water is affected by a degree of hydrolysis. The polyvinyl alcohol having a high hydrolysis rate has very low solubility in water. Therefore, polyvinyl alcohols having a degree of hydrolysis of 95% or less are preferred in order to easily constitute the aqueous slurry.

The molecular weight of the polyvinyl alcohol-based polymer is a factor that affects a binding property to various functional materials and separators, and polyvinyl alcohol-based polymers having a molecular weight of 5,000 to 100,000,000 g/mol may be generally used. Polyvinyl alcohol-based polymer having an extremely low molecular weight has poor binding strength, and polyvinyl alcohol-based polymer having an extremely high molecular weight has insufficient solubility in water, which makes it difficult to constitute the aqueous slurry.

As well as the polyvinyl alcohol-based polymer having a single molecular weight, the polyvinyl alcohol-based polymers having various molecular weights may also be mixed and used to fabricate the slurry. In this case, polyvinyl alcohol-based polymer having a low molecular weight may more focus on the role of surface modification, and polyvinyl alcohol-based polymer having a high molecular weight may contribute to increasing binding strength. The ratios of polyvinyl alcohol-based polymers having different molecular weights may be adjusted according to the purpose.

The polyvinyl alcohol-based polymer binder or a combination of various binders including the same may first be sufficiently dissolved in water, and then used to constitute the aqueous slurry. The functional material, the aqueous binder, and water, which constitute the aqueous slurry, may be added and mixed at one time. However, in this case, it may take a significant amount of time to dissolve the polymer. Therefore, a slurry is first prepared by sufficiently dissolving the polyvinyl alcohol-based polymer binder in water in order to avoid the local agglomerate. When a coating process is performed using this slurry, a functional film having more uniform properties may be fabricated.

A composition ratio of the functional material and the aqueous binder may be selected from between 60:40 and 99.9:0.1, preferably from between 80:20 and 99: 1, based on the weights thereof. A planetary mixer that revolves and rotates at the same time is preferably used to evenly mix the functional material, the aqueous binder, and water.

As described above, the polyvinyl alcohol-based polymer should certainly be included in the aqueous binder. The content of the polyvinyl alcohol-based polymer in the whole binder in the aqueous slurry including a multi-component binder system should be in a range of 5 to 100% by weight.

The viscosity of the slurry is not particularly limited as long as the slurry is in a high-viscosity state (greater than approximately 10,000 cP) with little fluidity and flowability. As described above, this is because the polyvinyl alcohol-based polymer modifies a surface of the hydrophobic separator to improve a wetting property of the aqueous slurry with which the hydrophobic separator is coated.

To coat the hydrophobic separator with the aqueous slurry, various film-formation processes such as a gravure coater method, a small-diameter gravure coater method, a reverse roll coater method, a transfer roll coater method, a kiss coater method, a deep coater method, a knife coater method, an air doctor blade coater method, a blade coater method, a bar coater method, a die coater method, a screen printing method, a spray coating method, and the like may be used.

As a drying method after coating, vacuum drying after hot-air drying is preferred, but is not limited as long as it can completely remove water in a coating layer. After a cell is assembled and a liquid electrolyte is injected, sufficient drying is required to satisfy a moisture content of several ppm or less in the liquid electrolyte. For this purpose, the vacuum drying is preferably performed for an hour. A temperature in a drying process is preferably limited to 100° C. or lower. As a main material of the separator, the polyolefin tends to be distorted or damaged at 100° C. or higher. Therefore, an extraordinarily high drying temperature may cause damage to the separator. More particularly, a drying temperature of 90° C. or lower is preferred.

A thickness of the coated functional material and the binder layer is preferably in a range of 1 to 10 micrometers. When the functional material and the binder layer are excessively thick, an increase in volume of the fabricated secondary battery including the functional material and the binder layer may be caused, which may have an influence in reducing an energy density per total volume of the secondary battery or reducing an energy density per weight of the secondary battery due to the weight of the functional material and the binder layer. Therefore, it is important to prevent an excessive decrease in the energy density per volume or the energy density per weight while imparting additional functions to the secondary battery by means of the functional material and the binder layer.

The fabricated functional material and the binder layer preferably have a porosity of 20% to 80%. When the porosities of the functional material and the binder layer are too low, it may be difficult to smoothly move a liquid electrolyte. On the other hand, when the porosities of the functional material and the binder layer are too high, it may be difficult to impart new functions to the separator.

The separator thus fabricated may be used as the separator for a secondary battery. In this case, as a positive electrode of the secondary battery, materials selected from sulfur, LiCoO₂, LiNiO₂, LiNiₓCo_{y}Mn_{z}O₂ (x+y+z=1), LiMn₂O₄, and LiFePO₄ may be used alone or in combination. As a negative electrode, materials selected from silicon, tin, graphite, and lithium may be used alone or in combination. For the mechanical binding strength and electrical conductivity of electrodes, it is common that the electrodes include a polymeric binder and a conductive material. In addition to the above-described aqueous polymers, polyvinylidene fluoride (PVdF), a styrenebutadiene rubber (SBR), a nitrile rubber (NBR), polyvinylpyrrolidone (PVP), and the like may be used as the polymeric binder. The materials selected from the above may be used alone or in combination. As the conductive material, materials selected from carbon black, carbon nanotube, and graphene may be used alone or in combination. A ratio of the active material, the polymeric binder, and the conductive material in the electrode may be selected from between 80:10:10 to 98:1:1. However, the electrode may further contain the polymeric binder or may further include the conductive material, depending on the properties of the electrode active materials.

A liquid electrolyte enabling operation of the secondary battery may be composed of a lithium salt and an organic solvent. The lithium salt may include LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, and LiC₄BO₈. The materials selected from the above may be used alone or in combination. As the organic solvent, a cyclic carbonate and a linear carbonate is generally mainly used alone or in combination. The cyclic carbonate includes butylene carbonate, ethylene carbonate, propylene carbonate, glycerin carbonate, vinylene carbonate, fluoroethylene carbonate, and the like, and the linear carbonate includes dimethyl carbonate, diethyl carbonate, ethyl methyl carbonate, dimethoxyethane, dimethyl ethylene carbonate, and the like. Dimethyl sulfoxide, acetonitrile, sulfolane, dimethyl sulfoxide, tetrahydrofuran, and the like may be used as the other organic solvents. The lithium salt in the liquid electrolyte may be selectively used at a concentration of 1 M to 5 M.

When necessary, a liquid electrolyte additive may be included to improve the performance of the secondary battery. Such an additive typically includes fluoroethylene carbonate, vinylene carbonate, and the like.

### Example 1

In this example, a method of fabricating a functional separator uniformly coated with a functional material based on an aqueous slurry composed only of a polyvinyl alcohol binder will be described in detail.

A fine powder of aluminum oxide having high affinity for a liquid electrolyte and high thermal stability was used as a functional material. An average particle size of the powder was approximately 279 nm. 10% by weight of polyvinyl alcohol was dissolved in water, and stirred at a temperature of 40° C. to facilitate dissolution. A slurry was fabricated based on 10 g of a solute, and a weight ratio of aluminum oxide and the polyvinyl alcohol was set to 97:3. Then, 3 g of an aqueous solution of 10% by weight of polyvinyl alcohol was mixed with 9.7 g of aluminum oxide. For uniform mixing, the resulting mixture was stirred at 2,000 rpm for 20 minutes using a planetary mixer. To prevent a lumping phenomenon of aluminum oxide particles, 10 zirconia balls (5 mm in size) were added and stirred together. To adjust the viscosity of the slurry, water was added, and then stirred at 2,000 rpm for another 3 minutes. Then, the viscosity of the slurry was adjusted to 229.1 cP. In this case, a content of water in the slurry was 50.5% by weight (based on the weight ratio).

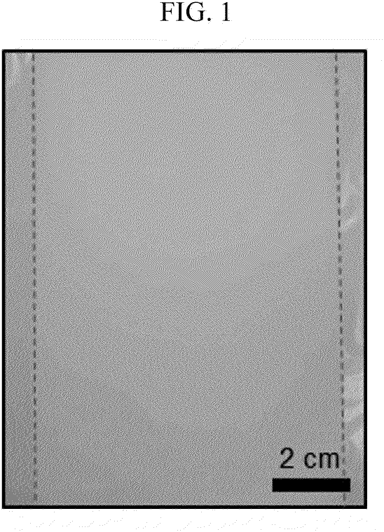

A process of coating a separator with the slurry was performed using a doctor blade method. The height of a doctor blade was adjusted to 15 µm and the coating process was performed to finally fabricate a coating layer of aluminum oxide/polyvinyl alcohol polymer having a thickness of 5 µm or less. FIG. 1 shows the aluminum oxide/polyvinyl alcohol layer with which the separator was coated.

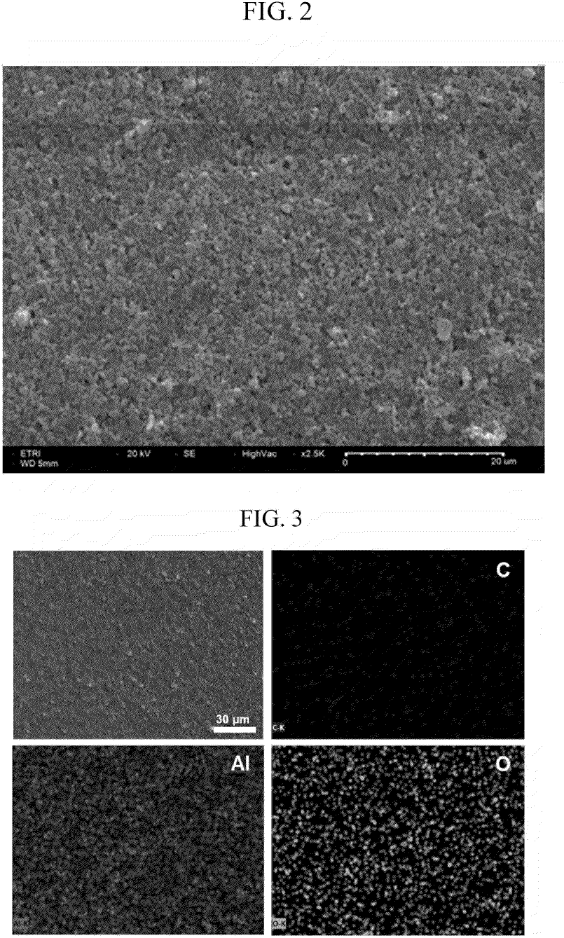

A region in which a coating process was performed was inside a red dashed line, and it can be seen that the entire surface of the separator was uniformly coated. The region coated with aluminum oxide had an even color of aluminum oxide without any glare caused by diffuse reflection of aluminum oxide, which was distinct from a region outside the red dashed line. For more accurate observation, the aluminum oxide-coated region was observed using an electron microscope and energy-dispersive X-ray spectroscopic analysis equipment. The results are shown in FIGS. 2 and 3. In FIG. 2, it can be seen the aluminum oxide particles were uniformly distributed, and that the uncoated separator was not exposed. It can be seen through the energy-dispersive X-ray spectroscopic analysis equipment of FIG. 3 that Al and O elements derived from the aluminum oxide were uniformly distributed throughout the surface of the separator. Further, the electron microscope and energy-dispersive X-ray spectroscopic analyses were performed on a cross-section of the separator. The results are shown in FIG. 4. It can be seen through the structural or element analysis that only an upper layer of the separator was uniformly coated with a functional layer.

### Example 2

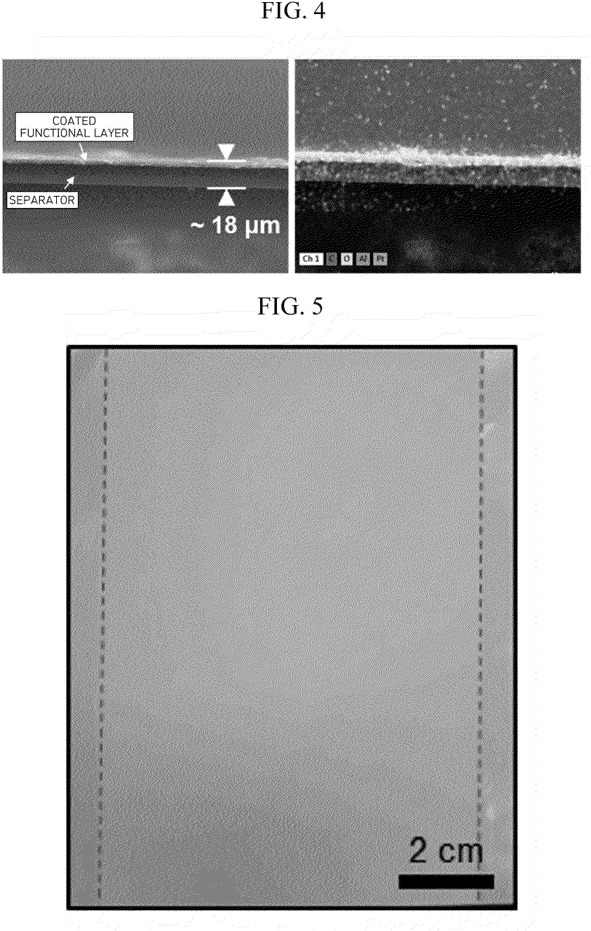

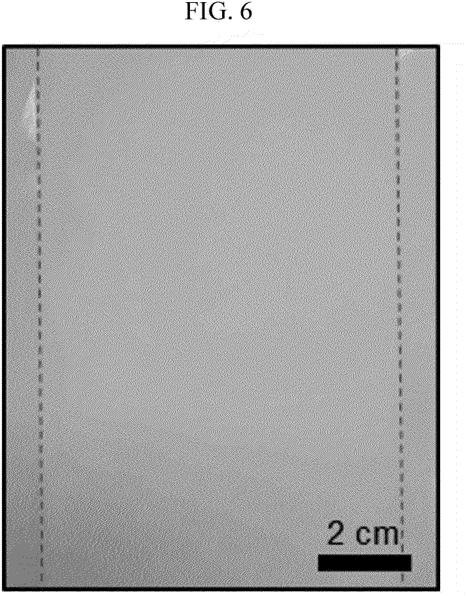

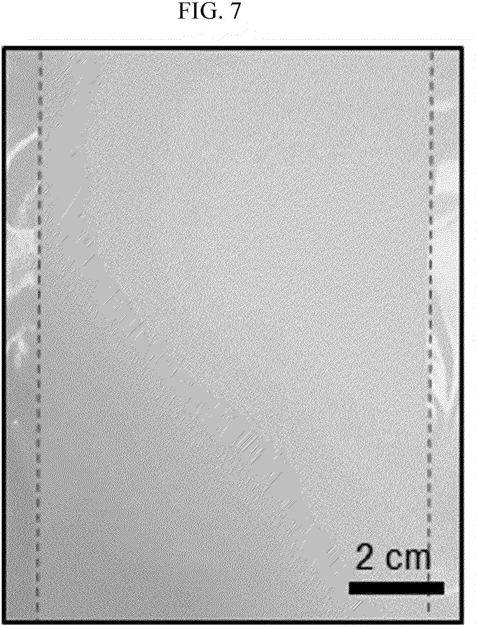

A process was performed in the same manner as in Example 1, except that the viscosity of the slurry was adjusted to 100.6 cP. In this case, a content of water in the slurry was 53.9% by weight (based on the weight ratio). FIG. 5 shows an aluminum oxide/polyvinyl alcohol layer with which the separator was coated. A region in which a coating process was performed was inside a red dashed line, and it can be seen that the entire surface of the separator was uniformly coated.

### Example 3

A process was performed in the same manner as in Example 1, except that the viscosity of the slurry was adjusted to 26.7 cP. In this case, a content of water in the slurry was 59.5% by weight (based on the weight ratio). FIG. 6 shows an aluminum oxide/polyvinyl alcohol layer with which the separator was coated. A region in which a coating process was performed was inside a red dashed line, and it can be seen that the entire surface of the separator was uniformly coated.

### Example 4

A process was performed in the same manner as in Example 1, except that the viscosity of the slurry was adjusted to 14.7 cP. In this case, a content of water in the slurry was 63.9% by weight (based on the weight ratio). FIG. 7 shows an aluminum oxide/polyvinyl alcohol layer with which the separator was coated. A region in which a coating process was performed was inside a red dashed line, and it can be seen that the entire surface of the separator was uniformly coated.

### Comparative Example 1

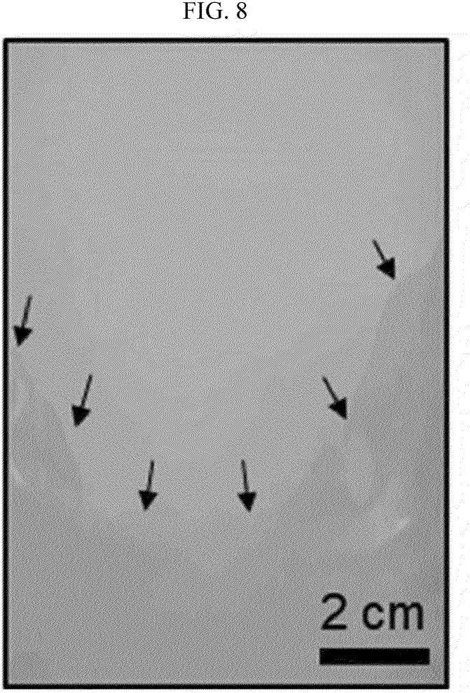

A process was performed in the same manner as in Example 1, except that the viscosity of the slurry was adjusted to 2,026 cP. In this case, a content of water in the slurry was 41.6% by weight (based on the weight ratio). FIG. 8 shows an aluminum oxide/polyvinyl alcohol layer with which the separator was coated. It can be seen that a coating boundary was observed due to non-uniform coating, compared to Examples 1 to 3. This indicates that the slurry did not sufficiently respond to the movement of the blade due to the excessively high viscosity of the slurry, and lost its fluidity. Based on the results, it can be seen that such a slurry composition was unsuitable for mass production of the functional separator.

### Comparative Example 2

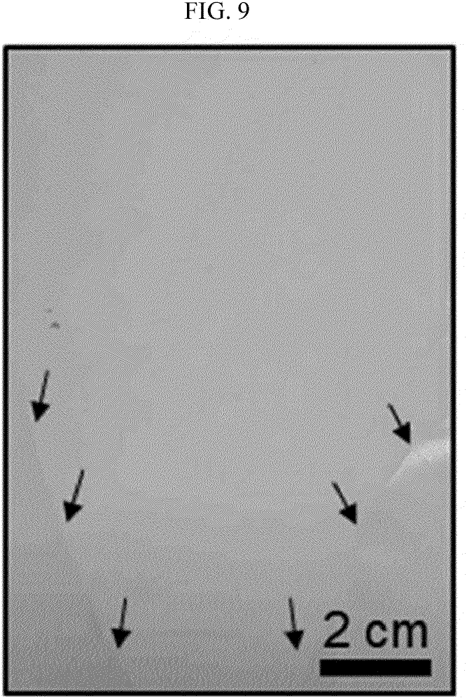

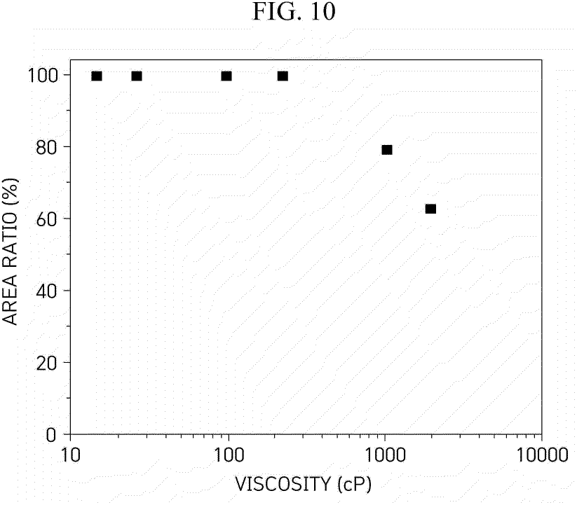

A process was performed in the same manner as in Example 1, except that the viscosity of the slurry was adjusted to 1,074 cP. In this case, a content of water in the slurry was 46.5% by weight (based on the weight ratio). FIG. 9 shows an aluminum oxide/polyvinyl alcohol layer with which the separator was coated. It can be seen that the coating uniformity was enhanced compared to Comparative Example 1, but a coating boundary was still observed due to non-uniform coating, compared to Examples 1 to 3. Based on the results, it can be seen that a slurry having a lower viscosity as in Examples 1 to 3 was preferred.

FIG. 10 is a graph showing a ratio of an area coated on the separator as a function of the viscosity of the aqueous slurry through an image analysis of Examples 1 to 4 and Comparative Examples 1 and 2. It can be seen that the whole area of the separator was able to be uniformly coated relative to the viscosity of the aqueous slurry (approximately 100%) in the case of Examples 1 to 4 (E1 to E4), but it was difficult to smoothly coat the separator with the functional material due to a great decrease in coating area ratio in the case of Comparative Examples 1 and 2 (C1 and C2). As described above, when the fluidity of a slurry was lost during a coating process, the mass production of the functional separator becomes fundamentally impossible. This tendency was identically observed in the aqueous slurry system using the polyvinyl alcohol-based polymer. Therefore, there was a slight difference in the absolute viscosity value between systems, but the uniform coating property at low viscosity was realized in all the configurations.

The table below summarizes the weight ratios of aluminum oxide, polyvinyl alcohol, and water used in each of Examples and Comparative Examples, the viscosity of the aqueous slurry, and the ratios of areas coated on the separator.

| | Aluminum oxide (% by weight) | Polyvinyl alcohol (% by weight) | Water (% by weight) | Viscosity (cP) | Coatingarea ratio (%) |
|---|---|---|---|---|---|
| Comp. Example 1 | 56.4 | 1.7 | 41.9 | 2026 | 62.8 |
| Comp. Example 2 | 51.9 | 1.6 | 46.5 | 1074 | 79.3 |
| Example 1 | 48.0 | 1.5 | 50.5 | 229.1 | 100 |
| Example 2 | 44.7 | 1.4 | 53.9 | 100.6 | 100 |
| Example 3 | 39.3 | 1.2 | 59.5 | 26.7 | 100 |
| Example 4 | 31.6 | 1.0 | 67.4 | 14.7 | 100 |

From the results of Examples 1 to 4 and Comparative Examples 1 and 2, it can be seen that the entire viscosity range of the aqueous slurry could be used for the uniform and smooth coating of the separator, except when the slurry including the polyvinyl alcohol binder had poor flowability due to the extraordinarily high viscosity of the slurry (Comparative Examples 1 and 2). Because it is useful to form an aluminum oxide/polyvinyl alcohol layer having a low thickness in terms of the energy density of the secondary battery, it is very important to uniformly coat the separator with the slurry having low viscosity. Accordingly, Examples 1 to 4 correspond very well to this fact.

### Example 5

In Example 5, a method of fabricating a functional separator using a mixed aqueous binder-based slurry is described in detail.

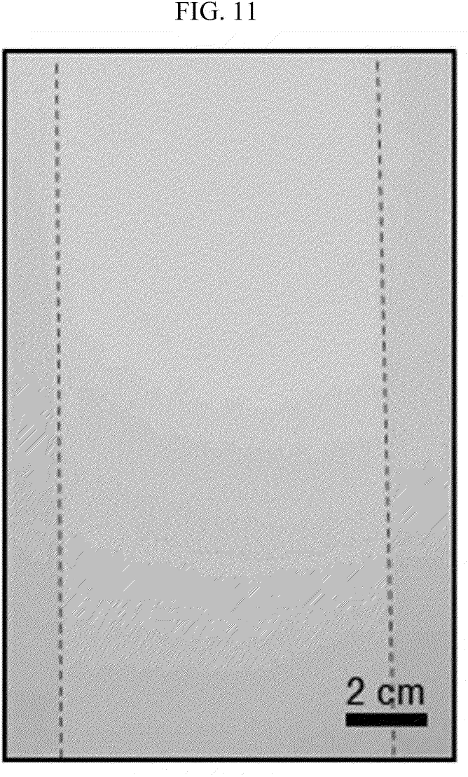

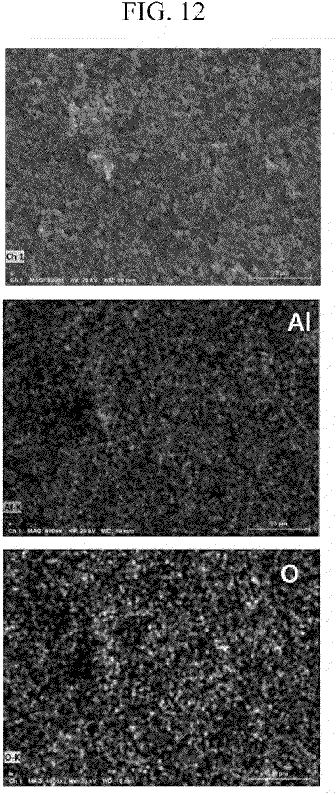

A mixed aqueous binder was composed of pectin and polyvinyl alcohol. A mixing ratio of pectin and polyvinyl alcohol was set to 1:1 (based on the weight ratio). An aqueous binder solution consisting of pectin and polyvinyl alcohol was used at concentrations of 6% by weight and 10% by weight, respectively, and a total amount of a solute in the slurry, a weight ratio of aluminum oxide and the mixed aqueous binder, the fabrication method, and the like were used in the same manner as in Example 1 (total amount of solute in slurry = 10 g, and weight ratio of aluminum oxide and mixed aqueous binders = 97:3). The viscosity of the slurry was adjusted to 63 cP by further adding water. FIG. 11 shows an aluminum oxide/polyvinyl alcohol/pectin layer with which the separator is coated. A region in which a coating process was performed was inside a red dashed line, and it can be seen that the entire surface of the separator was uniformly coated. Also, it can be seen that the same results were obtained through the electron microscope and energy-dispersive X-ray spectroscopic analyses further performed herein (see FIG. 12).

### Comparative Example 3

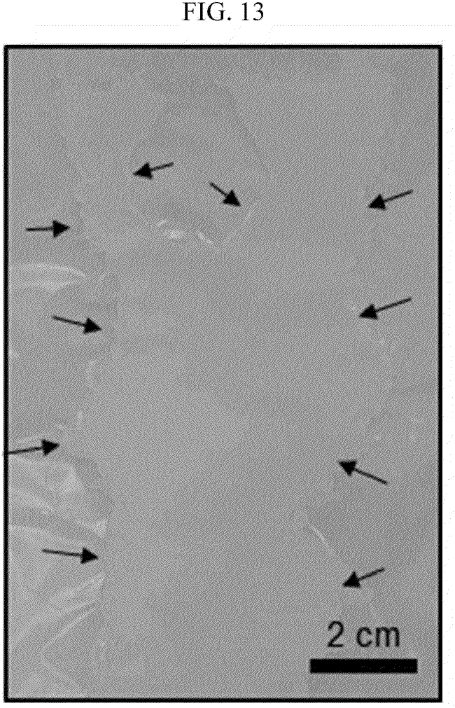

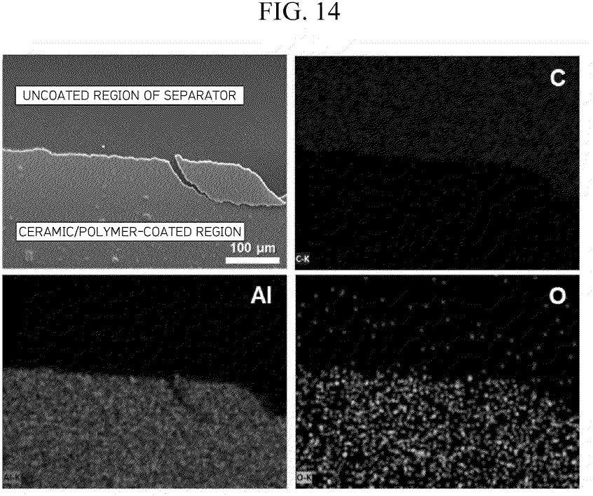

For comparison with Example 5, the coating results using an aqueous slurry composed of pectin alone were confirmed. The weight ratio of aluminum oxide and pectin was adjusted to 97:3 in the same manner as in Example 1. The coating results are shown in FIG. 13. It can be seen that it was impossible to smoothly coat the entire surface of the separator with the slurry, compared to Example 5, which is due to the low wetting property of the pectin-based aqueous slurry on the hydrophobic separator as described above. Further, it can be seen through precise electron microscope and energy-dispersive X-ray spectroscopic analyses that the slurry-coated region was clearly distinct from the uncoated region (see FIG. 14). Al and O elements derived from the aluminum oxide were very strongly observed in the slurry-coated region, whereas a polyolefin-based component (a C element) of the separator was observed in the uncoated region. Based on the results, the effects of the present invention may be proven.

It can be seen from Example 5 and Comparative Example 3 that the coating property on the hydrophobic separator was highly improved when polyvinyl alcohol was included in the aqueous slurry.

### Example 6

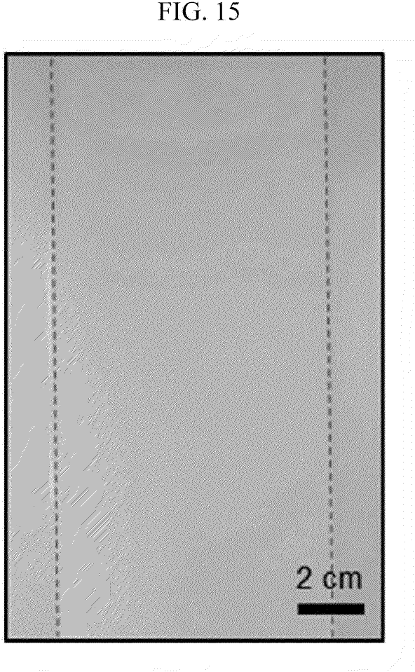

The same fabrication method as in Example 5 was performed in a mixed binder system of sodium carboxymethyl cellulose and polyvinyl alcohol. An aqueous binder solution of sodium carboxymethyl cellulose and polyvinyl alcohol was used at concentrations of 2% by weight and 10% by weight, respectively. The viscosity of the aqueous slurry was adjusted to 106 cP. The coating results are shown in FIG. 15. A region in which a coating process was performed was inside a red dashed line, and it can be seen that the entire surface of the separator was uniformly coated.

### Comparative Example 4

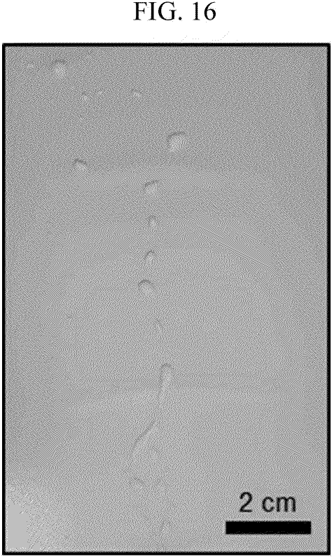

For comparison with Example 6, the coating results using an aqueous slurry composed of sodium carboxymethyl cellulose alone were confirmed. The weight ratio of aluminum oxide and pectin was adjusted to 97:3 in the same manner as in Example 1. The coating results are shown in FIG. 16. It can be seen that the coating was hardly formed, compared to Example 6.

Similar to the results of Example 5 and Comparative Example 3, it can be seen from the results of Example 6 and Comparative Example 4 that the coating property on the hydrophobic separator was highly improved when polyvinyl alcohol was included in the aqueous slurry.

The slurry composition according to the present invention can allow the fabrication of a functional separator to which further functions were imparted through the coating of the functional material, and finally can contribute to the improvement of performance of secondary batteries such as lithium-ion secondary batteries. Specifically, the present invention suggests a polyvinyl alcohol-based aqueous slurry composition capable of smoothly coating the hydrophobic separator. Thus, various combinations of functional materials and an aqueous binder slurry can be formed on the hydrophobic separator using the aqueous slurry composition.

The aqueous slurry-based functional separator thus fabricated can have various functions depending on the type of coated materials or secondary batteries. Here, the representative functional material may include aluminum oxide. When a separator uniformly coated with aluminum oxide particles is applied, an effect of improving the stability and performance of various lithium secondary batteries can be expected. As an example, when the aluminum oxide is applied to a separator for a liquid electrolyte-based lithium-ion secondary battery, thermal and mechanical stability can be improved. As another example, in the case of a lithium metal secondary battery using a lithium metal negative electrode, a lithium ion distribution can become more uniform, and a long-term lifespan characteristic and rate characteristics can be improved. As still another example, when the aluminum oxide is applied to a separator for a lithium-sulfur secondary battery, the aluminum oxide can physically and chemically capture polysulfide to improve a long-term lifespan characteristic of the lithium-sulfur secondary battery.

Meanwhile, the method of fabricating and applying the aqueous slurry according to the present invention has advantages in that an effect of environmental improvement becomes clear compared to the generally used method of fabricating an organic solvent-based slurry, and costs can be saved by approximately one tenth in terms of expenditure because an expensive organic solvent is excluded and the cost for facilities for recovery of organic solvents can be saved.

Although the present invention has been described in detail above with reference to the exemplary embodiments, those of ordinary skill in the technical field to which the present invention pertains should be able to understand that various modifications and alterations can be made without departing from the technical spirit or essential features of the present invention. Therefore, it should be understood that the disclosed embodiments are not limiting but illustrative in all aspects. The scope of the present invention is defined not by the above description but by the following claims, and it should be understood that all changes or modifications derived from the scope and equivalents of the claims fall within the scope of the present invention.

What is claimed is:

1. An aqueous slurry for coating a hydrophobic separator, comprising an aqueous binder comprising a polyvinyl alcohol-based polymer.

2. The aqueous slurry of claim 1, wherein the polyvinyl alcohol-based polymer of the aqueous binder is selected from polyvinyl alcohol, a polyvinyl alcohol derivative, and a copolymer comprising the polyvinyl alcohol.

3. The aqueous slurry of claim 1, wherein the polyvinyl alcohol-based polymer has a single molecular weight.

4. The aqueous slurry of claim 1, wherein the polyvinyl alcohol-based polymer is a mixture of polyvinyl alcohol-based polymers having various molecular weights.

5. The aqueous slurry of claim 1, wherein the molecular weight of the polyvinyl alcohol-based polymer is selected from a range of 50,000 g/mol to 100,000,000 g/mol.

6. The aqueous slurry of claim 1, further comprising a functional material.

7. The aqueous slurry of claim 6, wherein the functional material comprises at least one selected from aluminum oxide, silicon dioxide, titanium dioxide, zirconium dioxide, ruthenium oxide, iron oxide, cobalt oxide, nickel oxide, boehmite, copper, silver, iron, nickel, carbon black, carbon nanotubes, graphene, and graphite.

8. The aqueous slurry of claim 6, wherein the functional material has an average particle size of 100 nanometers to 5 micrometers.

9. The aqueous slurry of claim 1, further comprising a heterogeneous aqueous binder other than the polyvinyl alcohol-based polymer.

10. The aqueous slurry of claim 9, wherein the heterogeneous aqueous binder other than the polyvinyl alcohol-based polymer comprises at least one selected from polyethylene oxide (PEO), polyvinyl pyrrolidone (PVP), polyacrylamide, poly N-(2-hydroxypropyl)methacrylamide (HPMA), polyethyleneimine (PEI), polyacrylic acid (PAA), a divinyl ether-maleic anhydride, polyoxazoline, polyphosphate, polyphosphazene, xanthan gum, pectin, dextran, carrageenan, guar gum, sodium carboxymethyl cellulose, sodium alginate, hyaluronic acid, and albumin.

11. The aqueous slurry of claim 6, wherein a composition ratio of the functional material and the aqueous binder is selected from between 60:40 and 99.9:0.1, based on the weight ratio thereof.

12. A separator for a secondary battery coated with an aqueous slurry comprising an aqueous binder, which comprises a polyvinyl alcohol-based polymer selected from polyvinyl alcohol, a polyvinyl alcohol derivative, and a copolymer comprising the polyvinyl alcohol.

13. The separator of claim 12, wherein the aqueous slurry further comprises a functional material.

14. The separator of claim 13, wherein the functional material comprises at least one selected from aluminum oxide, silicon dioxide, titanium dioxide, zirconium dioxide, ruthenium oxide, iron oxide, cobalt oxide, nickel oxide, boehmite, copper, silver, iron, nickel, carbon black, carbon nanotubes, graphene, and graphite.

15. The separator of claim 13, wherein the functional material has an average particle size of 100 nanometers to 5 micrometers.

16. The separator of claim 12, wherein the aqueous slurry further comprises a heterogeneous aqueous binder other than the polyvinyl alcohol-based polymer.

17. The separator of claim 16, wherein the heterogeneous aqueous binder other than the polyvinyl alcohol-based polymer comprises at least one selected from polyethylene oxide (PEO), polyvinyl pyrrolidone (PVP), polyacrylamide, poly N-(2-hydroxypropyl)methacrylamide (HPMA), polyethyleneimine (PEI), polyacrylic acid (PAA), divinyl ether-maleic anhydride, polyoxazoline, polyphosphate, polyphosphazene, xanthan gum, pectin, dextran, carrageenan, guar gum, sodium carboxymethyl cellulose, sodium alginate, hyaluronic acid, and albumin.

18. The separator of claim 12, wherein a composition ratio of the functional material and the aqueous binder is selected from between 60:40 and 99.9:0.1, based on the weight ratio thereof.

19. The separator of claim 12, wherein a thickness of the coated aqueous slurry is between 1 micrometer and 10 micrometers.
